(19) United States
(12) Patent Application Publication
(10) Pub. No.: US 2016/0132968 A1
(43) Pub. Date: May 12, 2016

(54) MEANS AND METHOD OF INVESTMENT PORTFOLIO MANAGEMENT

(71) Applicant: Amir AYAL, HERZELIA PITUACH (IL)

(72) Inventor: Amir AYAL, HERZELIA PITUACH (IL)

(21) Appl. No.: 14/997,543

(22) Filed: Jan. 17, 2016

Related U.S. Application Data
(63) Continuation-in-part of application No. 13/519,033, filed on Jul. 18, 2012.
(60) Provisional application No. 61/290,020, filed on Dec. 24, 2009.

(51) Int. Cl. G06Q 40/06

(52) U.S. Cl. CPC G06Q 40/06

(57) ABSTRACT

A diversified composite portfolio can be formed by selecting a bundle of investment securities, correlating them according to a user specific risk tolerance value, and assigning relative portfolio performance metric to the components based on calculated risk tolerance value.

### FIELD OF THE INVENTION

The present invention relates generally to computerized techniques using a logical data model for constructing a diversified composite portfolio of investment securities based on investor's personal financial risk tolerance level analysis.

### BACKGROUND OF THE INVENTION

Management of investment portfolios has been the subject of substantial theory and research. Portfolio theory considers how one's funds should be invested and how to maximize a portfolio's expected return for a given amount of portfolio risk, or equivalently minimize risk for a given level of expected return, by carefully choosing the proportions of various assets. Current portfolios are selected using the following rules: (a) from the portfolios that have the same return, the investor will prefer the portfolio with lower risk, and (b) from the portfolios that have the same risk level, an investor will prefer the portfolio with higher rate of return.

U.S. Pat. No. 5,101,353 to Lupien et al. discloses an apparatus and a method for broadly increasing liquidity and depth in such markets by trading portions of normally dormant portfolios including those with numerous and diverse securities. The invention seeks to accomplish this without substantially increasing the risk of loss to holders of those portfolios by maintaining an approximation of the desired investment mix in those portfolios while reacting to market pressures so as to generate incremental returns to portfolio holders. This patent is concerned about the liquidity of a portfolio, and is not aimed at reducing the investor's anxiety by separately managing high risk and low risk portfolios.

U.S. Pat. No. 7,509,274 to Kam et al. discloses a system of attracting and identifying the best investors, including offering and managing performance-based investment competitions based on model investment portfolios, creating actual portfolios for the identified best investor, creating and operating actual mutual funds based on the identified best investors as fund managers, and providing a full suite of related subscriber and investor services associated therewith as a fund supermarket. This patent is concerned about creation of general portfolios, without dealing with the risk factor, and is not aimed at reducing the investor's anxiety by separately managing high risk and low risk portfolios.

U.S. Pat. No. 7,110,971 to Wallman discloses a method and apparatus for electronically trading over wired and wireless networks, including over the Internet, and investing in securities or other assets, rights or liabilities that enables a user, at a reasonable cost, to create and manage a complex and diversified portfolio of such securities or other assets, rights or liabilities. This patent discloses an electronically trading apparatus, and is not aimed at reducing the investor's anxiety by separately managing high risk and low risk portfolios.

U.S. Pat. No. 7,373,324 Engin et al. discloses a computer system for facilitating the distribution of financial investment advice. This patent is not aimed at reducing the investor's anxiety by separately managing high risk and low risk portfolios.

U.S. Pat. No. 7,120,601 to Chen et al. discloses a method and system for allocating retirement savings to finance retirement consumption. More particularly, the present invention relates to a method and system for optimally allocating investment assets within and between annuitized assets and non-annuitized assets having different degrees of risk and return. This patent is not aimed at reducing the investor's anxiety by separately managing high risk and low risk portfolios.

U.S. Pat. No. 7,430,532 to Wizon et al. discloses a system and method for effectuating a transaction involving financial instruments such as fixed income securities, and more particularly, to a system and method for conducting a risk analysis on a fixed income security and subsequently initiating a trade of that security. This patent is not aimed at reducing the investor's anxiety by separately managing high risk and low risk portfolios

U.S. Pat. No. 6,859,788 to Davey discloses an automated system and method for the assessment of an individual's attitude towards financial risk. This patent is not aimed at reducing the investor's anxiety by separately managing high risk and low risk portfolios

Risk is involved where a choice has to be made, and there is uncertainty about the outcome of at least one of the alternatives. Risk tolerance is the level of risk with which an individual is comfortable. As such, it is a personal attribute. In relation to an individual's attitude towards financial risk, it is desirable from many points of view to make an assessment of risk tolerance.

Studies confirm that people generally do not accurately estimate their own risk tolerance levels (and, not surprisingly, given the difficulties in any communication about an intangible, their financial advisors' estimates are less accurate than their own). While the findings are scattered, there is a slight overall tendency to over-estimate risk tolerance. A possible explanation for this is that the majority of the population is, in absolute terms, more risk-avoiding than it is risk-seeking. Faced with a choice between a certain profit and an uncertain, but probably larger profit, a sizeable majority chooses the certain (but probably smaller) profit. Someone, who in absolute terms is slightly risk-averse, may not realize that this is typical of the population as a whole.

An automatic analysis of individuals' Personal Financial Risk Tolerance (PFRT) logical data model provides knowledge that may assist in making appropriate decisions concerning said individual's financial position. These decisions will be ‘appropriate’ in the sense that they involve a level of risk in keeping with the individual's risk tolerance level. Such information will be of use both for the individuals themselves, and for their financial advisors, who will then be able to assist clients in making financial decisions in a manner more in sympathy with their clients' attitude towards risk. For example, where an advisor would normally commend a course of action which involves a level of risk greater than the client's tolerance, both client and advisor can be notified in real time of the conflicts so that they can work towards a compromise. Similarly, where a course of action involves a level of risk lower than the client's risk tolerance, the client and the advisor can decide to shift investment to riskier instruments. Without assessment of the individual PFRT logical data model, such conflicts between desired and actual levels of financial risk may never be identified, or possibly worse, may be identified after the fact.

The Financial Services industry touches every adult to some extent. Credit, banking, investment decisions, insurance, loans, purchases, and so on are all parts of the Financial Services industry, which underpins the very foundation of modern day society.

A known risk tolerance instrument is described in the “Survey of Financial Risk Tolerance” (SOFRT), developed by The American College, of 270 S. Bryn Mawr Avenue, Bryn Mawr, Pa. 19010, and released in 1994. The College is a private US University established by the Insurance industry in the 1970s. The author of the survey is Michael J. Roszkowski PhD. The above-referenced risk tolerance instrument operates by providing an individual with a questionnaire. Each answer is scored by using the number chosen. The sequence of choices is either from low risk to high risk, or high risk to low risk. In the latter case, the choice numbers are reversed during scoring. Two overall scores are then calculated: a Risk Tolerance Score and a Consistency Score. The Risk Tolerance Score is scaled linearly in the range 0, which represents total risk averse, to 100, which represents total risk enthusiastic.

The PFRT logical data model of an individual is especially important in determining the above-average risk portion size, out of the individual total investment capital, that keeps the individual comfortable.

Another example of a survey for risk assessment is the Survey of Consumer Finances (SCF) which contains a single risk assessment item: “which of the following statements comes closest to the amount of financial risk that you are willing to take when you save or make investments? (1) Take substantial financial risk expecting to earn substantial return. (2) Take above average financial risk expecting to earn above average return. (3) Take average financial risk expecting to earn average return. (4) Not willing to take any financial risks.”

The anxiety of the investor, in face of a fast decreasing market, like the stock market crash that took place during the year 2008, is another important factor to be taken into account. In accordance with the above background, this risk tolerance can be associated to great extent to the subjective fear of capital loss as perceived by the investor. Risk tolerance is much intensified in face of bigger market uncertainties, i.e. lack of knowledge on the size of the capital in risk for loss. Investor anxiety causes the investor to make irrational decisions which can cause financial harm with far reaching effects.

Risk tolerance can be measured by applying other logical data models, such as the State-Trait Anxiety Inventory (STAI), an investment variation of modified Yale Preoperative Anxiety Scale (mYPAS), modified visual scales like Wong-Baker FACES scale, other custom made scales etc.

The systems and methods described herein can be used in investment management by controlling for specific types of investors' tolerance levels that impact the overall randomness of risk and return in investment securities.

### SUMMARY OF THE INVENTION

### The Risk Tolerance Data Model

Academic knowledge in behavioral economics and behavioral finance has increased tremendously in recent years. Work by Nobel Prizewinning professors Kahneman and Twersky has demonstrated the use of cognitive models of decision-making under risk and uncertainty to explain economic models of rational and irrational human behavior and decision making. Behavioral economics and finance theories were originally developed from experimental observations and survey responses, but recently brain imaging technology has enabled the direct observation of brain activity during economic decision making, as well as related stress, anxiety and euphoric responses to real or perceived financial investment situations. Nevertheless, until now, there has been no real progress in applying this new knowledge of emotionally and perceptional driven individual economic behavior to practical proven asset management mechanism and portfolio management.

Computerized techniques using a logical data model for constructing a diversified composite portfolio of investment securities are herein described which exploit the linkage between behavioral finance and individual investment rationale.

This present invention provides and discloses a novel analytical computerized system and associated algorithms useful for constructing a database representation of investment securities that automatically correlate to analyzed user tolerance level and manage an investment portfolio according to a user specific financial risk tolerance value. The avoidance of costly irrational decisions is crucial to maximizing gains over a given period of time.

The breakthrough here is that the individual investor is assessed for risk tolerance and for euphoric gain impact. An investment portfolio is automatically represented and selected to optimize metrics related both to ROI and the given user risk tolerance.

The core of the present invention is to provide a system and methods for constructing a database representation of investment securities based on user personal financial risk tolerance value in infinite number of separate and independently managed portfolios, on a range of high-risk portfolio and low-risk portfolios, each correlating to different metrics of a user risk tolerance value.

It is within the scope of the present invention to disclose a computer-implemented method for constructing a database representation of diversified investment securities correlating to user risk tolerance value, the method comprising: electronically storing a set of data entities in a database system, each of the data entities representing an analyzed personal risk tolerance value; electronically storing a set of data entities in a database system, each of the data entities representing an investment security bundle; electronically assigning tags representing attributes of the analyzed personal risk tolerance values to a plurality of the investment securities bundles; selecting a plurality of investment securities bundles represented by data entities for inclusion in a plurality of portfolios of investment securities; correlating the selected investment securities bundles corresponding to an analyzed personal risk tolerance values into at least a first high risk diversified group and a second low risk diversified group based on at least one first common high risk attribute and at least one second common low risk attribute accordingly, the analyzed personal risk tolerance values represented by investment securities bundles in the first high risk diversified group share at least one first common high risk attribute, as identified by one or more tags, and the analyzed personal risk tolerance values represented by investment securities bundles in the second low risk diversified group share the second common attribute, as identified by one or more tags; electronically storing the selected investment securities bundles as a database representation of portfolio; and enabling a creating, reading, updating, or deleting operation on the database system representation of the portfolio in the database system.

It should be emphasized that the user himself may carry out the aforementioned transactions, which has certain advantages over systems entirely controlled by a financial advisor. For example, the investor may enjoy a greater feeling of control over his/her finances, may be more assured that the results obtained are due to his/her own efforts, and may be less susceptible to suspect that results obtained are due to inferior management. Finally, the investor may derive an increased sense of safety if he/she is the party to carry out transactions. The tendency of an investor to make irrational decisions due to anxiety is reduced by the implementation of the means and methods provided by the present invention and herein disclosed.

It is within the scope of the present invention to disclose a system for executing a command in a computing environment to construct a representation of diversified investment securities correlating to user risk tolerance value in a database, the system comprising: a computerized processor configured for: electronically assigning tags representing attributes of the analyzed personal risk tolerance values to a plurality of the investment securities bundles; selecting a plurality of investment securities bundles represented by data entities for inclusion in a plurality of portfolios of investment securities; correlating the selected investment securities bundles corresponding to an analyzed personal risk tolerance values into at least a first high risk diversified group and a second low risk diversified group based on at least one first common high risk attribute and at least one second common low risk attribute accordingly, wherein the analyzed personal risk tolerance values represented by investment securities bundles in the first high risk diversified group share at least one first common high risk attribute, as identified by one or more tags, and the analyzed personal risk tolerance values represented by investment securities bundles in the second low risk diversified group share the second common attribute, as identified by one or more tags; enabling a creating, reading, updating, or deleting operation on the database system representation of the portfolio in the database system; an electronic data store configured for: electronically storing a set of data entities in a database system, each of the data entities representing an analyzed personal risk tolerance value; electronically storing a set of data entities in a database system, each of the data entities representing an investment security bundle; and electronically storing the selected investment securities bundles as a database representation of portfolio.

### BRIEF DESCRIPTION OF THE DRAWINGS

In order to better understand the invention and its implementation in a practice, a plurality of embodiments will now be described, by way of non-limiting example only, with reference to the accompanying drawings, in which

FIG. 1 illustrates an example method for constructing a diversified composite portfolio of investment securities based on investor's personal financial risk tolerance level analysis;

FIG. 2 graphically illustrates, according to another preferred embodiment of the present invention, a flow chart, according to another preferred embodiment, of the present invention method for constructing a database representation of diversified investment securities correlating to user risk tolerance value;

FIG. 3 graphically illustrates, according to the preferred embodiment of the present invention, a flow chart of the method for rebalancing a database representation of diversified investment securities correlating to user risk tolerance value; and

FIG. 4 graphically illustrates, according to another preferred embodiment of the present invention, an example of computerized system for implementing the invention.

### DETAILED DESCRIPTION OF THE PREFERRED EMBODIMENTS

The following description is provided, along all chapters of the present invention, so as to enable any person to make use of said invention and sets forth the best modes contemplated by the inventor of carrying out this invention. As is customary, it will be understood that no limitation of the scope of the invention is thereby intended. Further modifications will remain apparent to those skilled in the art, since the generic principles of the present invention have been defined specifically to provide means and methods for managing an investment portfolio management according to an investor's personal financial risk tolerance or anxiety level.

The terms “investor”, “customer”, “client” and “user”, used interchangeably in the present invention, refers hereinafter to any party that makes an investment.

The terms “capital” refers hereinafter to any financial assets or to the financial value of assets.

The terms “custom-made” and “custom-tailored”, used interchangeably in the present invention, refers hereinafter to any action that is performed in order to accommodate the special needs, desires or requirements of a certain investor or customer.

The term “cash allocation” refers hereinafter to the partition of capital, funds, money, securities etc. to at least two portfolios or sub portfolios, or between these portfolios or sub portfolios.

The term “leverage” refers hereinafter to any technique or attribute for multiplying gains.

The term “optimal portfolio model” refers hereinafter to any model for building a portfolio such that an optimal portfolio is obtained in terms of one or more of a variety of factors such as expected return and standard deviation of the portfolio. Alternatively or additionally this can refer to a portfolio consisting of a weighted sum of every asset in the market, with weights in the proportions that they exist in the market creation method.

The terms “base capital”, “low-risk capital” and “no-risk capital”, used interchangeably in the present invention, refers hereinafter to cash, money, funds, capital, securities etc. that are invested in substantially below-average-risk financial tools, selected from a group consisting of, stocks, securities, funds, mutual funds, currency market, options, commodities, etc. or any combination thereof.

The terms “venture capital”, “risk capital” and “high risk capital”, used interchangeably in the present invention, refers hereinafter to cash, money, funds, capital, securities etc. that are invested in substantially above-average-risk financial tools, selected from a group consisting of, stocks, securities, funds, mutual funds, currency market, options, commodities, etc. or any combination thereof.

The terms “volatility” and “variation”, used interchangeably in the present invention, refers hereinafter to the amount of uncertainty or risk due to changes in a security's value, or to a statistical measure of the dispersion of returns for a given security or market index. Volatility can either be measured by using the standard deviation or variance over some time period for that same security or market index.

The terms “return” and “yield”, used interchangeably in the present invention, refer hereinafter to the gain or loss of a security in a particular period, or to the income return on an investment. The return includes interest and dividends received from a security and is usually expressed as an annual percentage change based on the investment's original cost, its current market value, or its face value.

The term “capital preservation” refers hereinafter to the preservation or safeguarding of capital, funds, money, cash, securities, portfolio etc. by any action taken in order to avoid undesired loss. This term refers to loss from the total investment portfolio of the investor, and not loss from a particular investment.

The term “capital appreciation” refers hereinafter to the appreciation or raise in value of capital, funds, money etc. by any action taken in order to increase the gains.

The term “investment manager” refers hereinafter to any organization, firm, company, corporation, government agency, bank, broker or body that manages an investment.

The term “bull market” refers hereinafter to financial market of a group of securities in which prices are rising or are expected to rise.

The term “bear market” refers hereinafter to a market condition in which the prices of securities are falling, and widespread pessimism causes the negative sentiment to be self-sustaining.

The term “annual return” refers hereinafter to the annual change or rate of change either in terms of nominal value or real value or the annual currency rate change, inflation related annual change, interest rate change, any other annual or periodical change, or any combination thereof.

The term “personal financial risk tolerance” or “PFRT” refers hereinafter to any value designated to electronically calculate and assert the user specific financial risk tolerance.

The term “survey of financial risk tolerance” or “SOFRT” refers hereinafter to the tool developed by The American College of Bryn Mawr and released in 1994, designed to measure the PFRT of an individual.

The term “return on investment” or “ROI” refers hereinafter to any performance measure used to evaluate the efficiency of an investment or to compare the efficiency of a number of different investments.

The terms “gain accelerator” and “gain acceleration”, used interchangeably in the present invention, refers hereinafter to increase of the rate of change of the gain, to the increase of the change of gain or the increase of the gain itself, or to a means for performing any of these increases.

The terms “loss decelerator” and “loss deceleration”, used interchangeably in the present invention, refers hereinafter to the limiting of the rate of change of the loss incurred in any portfolio, or to the limiting of the change of the loss, or to the limiting of the loss itself, or to a means for performing any of these limiting.

The term “well-known benchmarks” refers hereinafter to comparison means selected from a group consisting of any index, currency rate, historic rate average, bonds performance, Treasury bond performance, average bank deposit rates, other deposit rates, any other popular index, rates or any combination thereof.

The term “investment security” refers hereinafter to an investment security is defined as a financial instrument that can represent any or all of: an ownership position in a corporation (stock) or a collection of assets; a creditor relationship with a corporation; an individual or a governmental body secured directly or indirectly by the assets of the issuer (bond); or rights to ownership as represented by an option or other derivative instrument. An investment security may be a fungible, negotiable, financial instrument that represents a type of financial value associated with an entity. Its value can be based on the type of security, the type of relationship with the issuer, and the type of assets and liabilities that are directly or indirectly associated with the security.

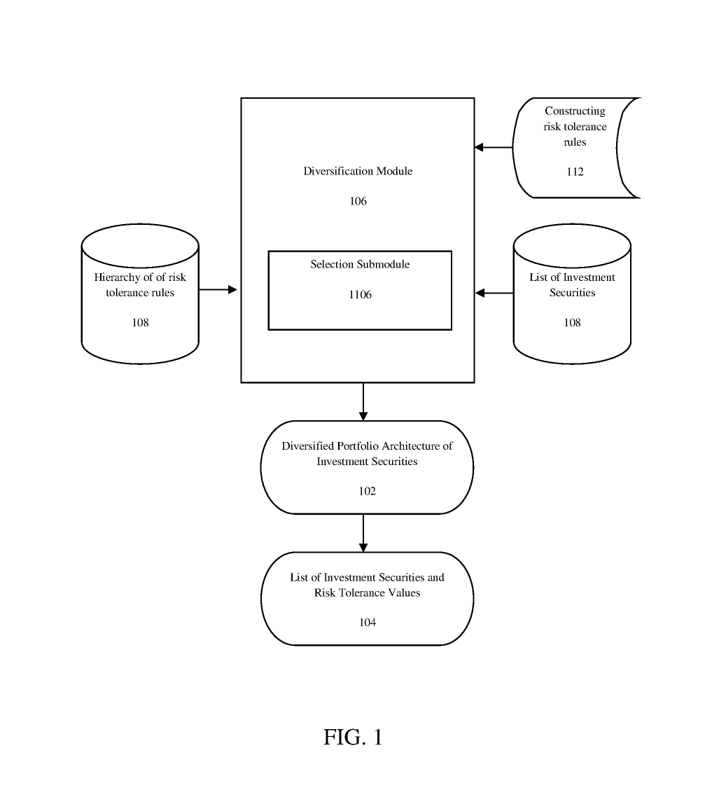

In one embodiment, a diversified composite portfolio can include an identification of multiple investment securities and correlating risk tolerance values. As a non-limiting example, the identifications and values can be executed using a computerized process according to the example method illustrated in FIG. 1. As illustrated in FIG. 1, the method can first generate a diversified portfolio architecture 102 and then a resultant list of investment securities and correlating risk tolerance values 104. In an initial step, a diversification module 106 can receive as inputs investment security entities 108 and a hierarchy of risk tolerance rules 110, both of which can be stored on one or more computerized data storage devices. The risk tolerance rules can be provided by electronically calculating the investor's risk tolerance by means such as the Risk Tolerance Score, the State-Trait Anxiety Inventory (STAI), the Yale Preoperative Anxiety Scale (mYPAS), and the Wong-Baker FACES scale. The score provided by one or more of these calculations are combined and normalized to reach the risk tolerance value, which is then can be benchmarked and correlated to the actual risk for the portfolio architecture, as described above. The rules can define relationships between risk tolerance and the investment securities associated with the risk tolerance values. The diversification module 106 can also include a selection submodule 1106 to receive, as input, a selection from a user of investment securities and/or risk tolerance rules 112. In some embodiments, the rules and/or the structure of the rules may be predefined. In other embodiments, a preexisting set of the rules may be edited by a user or the set of rules may be defined by the user. In other embodiments, the user can be provided with an interface for creating new rules which are then input to the diversification module 106.

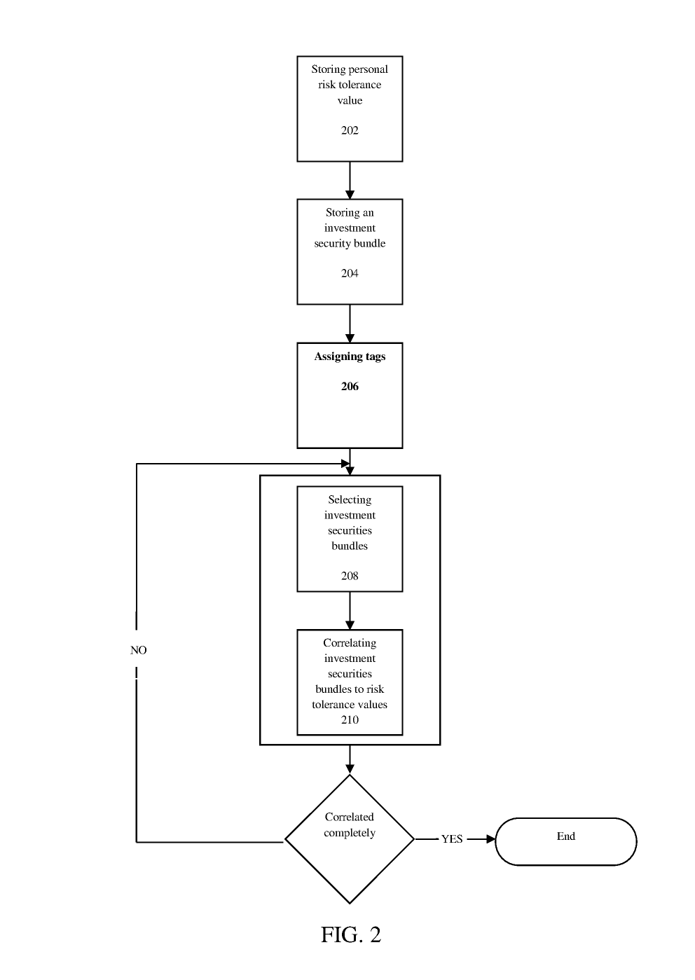

Reference is made now to FIG. 2 which illustrates a flow chart, according to another preferred embodiment, of the present invention method for constructing a database representation of diversified investment securities correlating to user risk tolerance value. As illustrated in FIG. 2, the method can first electronically storing a set of data entities in a database system, each of the data entities representing an analyzed personal risk tolerance value using a computerized process 202; electronically store a set of data entities in a database system, each of the data entities representing an investment security bundle 204; electronically assign tags 206 representing relations of the analyzed personal risk tolerance values to a plurality of the investment securities bundles; select a plurality of investment securities bundles 208 represented by data entities for inclusion in a plurality of portfolios of investment securities; correlate the selected investment securities bundles 210 corresponding to an analyzed personal risk tolerance values into at least a first high risk diversified group and a second low risk diversified group based on at least one first common high risk attribute and at least one second common low risk attribute accordingly, the analyzed personal risk tolerance values represented by investment securities bundles in the first high risk diversified group share at least one first common high risk attribute, as identified by one or more tags, and the analyzed personal risk tolerance values represented by investment securities bundles in the second low risk diversified group share the second common attribute, as identified by one or more tags. Further to the disclosed above step 210 the method can eventually electronically store the selected investment securities bundles as a database representation of portfolio; and enable a creating, reading, updating, or deleting operation on the database system representation of the portfolio in the database system.

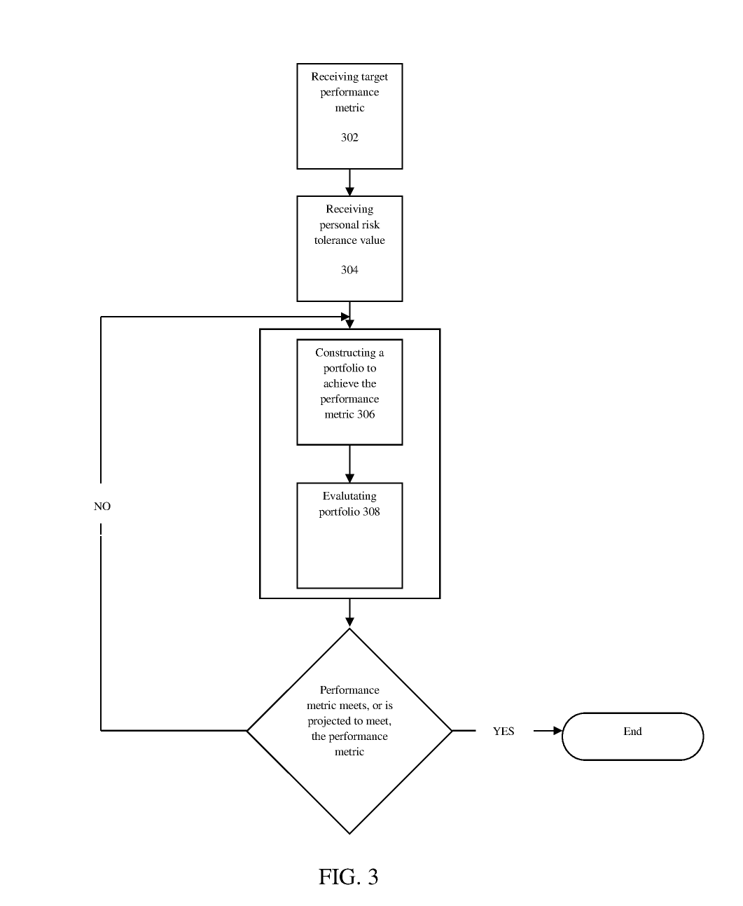

Reference is made now to FIG. 3 which graphically illustrates, according to the preferred embodiment of the present invention, a flow chart of the method for rebalancing a database representation of diversified investment securities correlating to user risk tolerance value. As illustrated in FIG. 3, the method can first receive, as an input, a target performance metric from a user 302; receive, as an input, an analyzed personal risk tolerance value of said user 304; evaluate a portfolio to determine whether it meets, or is projected to meet, the performance metric; and/or subsequently construct a portfolio, group, or subgroup so as to achieve the performance metric.

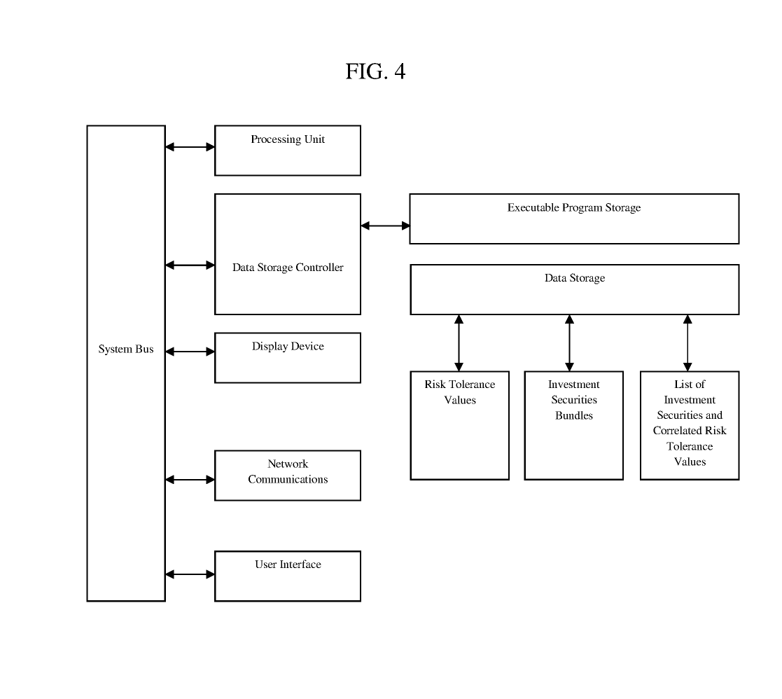

Reference is made now to FIG. 4 which graphically illustrates, according to another preferred embodiment of the present invention, an example of computerized system for implementing the invention. The systems and methods described herein can be implemented in software or hardware or any combination thereof. The systems and methods described herein can be implemented using one or more computing devices which may or may not be physically or logically separate from each other. Additionally, various aspects of the methods described herein may be combined or merged into other functions.

In some embodiments, the illustrated system elements could be combined into a single hardware device or separated into multiple hardware devices. If multiple hardware devices are used, the hardware devices could be physically located proximate to or remotely from each other.

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as an LCD (liquid crystal display), or another type of monitor for displaying information to the user, and a keyboard and an input device, such as a mouse or trackball by which the user can provide input to the computer.

A computer program can be a set of instructions that can be used, directly or indirectly, in a computer. The systems and methods described herein can be implemented using programming languages such as Flash™, JAVA™, C++, C, C#, Visual BasicT™, JavaScript™, PHP, XML, HTML, etc., or a combination of programming languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™, Apple™ Mac™, iOS™, Unix™/X-Windows™, Linux™, etc. The system could be implemented using a web application framework, such as Ruby on Rails.

The processing system can be in communication with a computerized data storage system. The data storage system can include a non-relational or relational data store, such as a MySQL™ or other relational database. Other physical and logical database types could be used. The data store may be a database server, such as Microsoft SQL Server™, Oracle™, IBM DB2™, SQLITE™, or any other database software, relational or otherwise. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database. The systems and methods described herein can be implemented using any number of physical data models. In one example embodiment, an RDBMS can be used. In those embodiments, tables in the RDBMS can include columns that represent coordinates. In the case of economic systems, data representing companies, products, etc. can be stored in tables in the RDBMS. The tables can have pre-defined relationships between them. The tables can also have adjuncts associated with the coordinates.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The systems, modules, and methods described herein can be implemented using any combination of software or hardware elements. The systems, modules, and methods described herein can be implemented using one or more virtual machines operating alone or in combination with each other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

While one or more embodiments of the invention have been described, various alterations, additions, permutations and equivalents thereof are included within the scope of the invention.

In the description of embodiments, reference is made to the accompanying drawings that form a part hereof, which show by way of illustration specific embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other embodiments using alternative orderings of the computations could be readily implemented. In addition to being reordered, the computations could also be decomposed into sub-computations with the same results.

1. A computer-implemented method for constructing a database representation of diversified investment securities correlating to user risk tolerance value, the method comprising:
a. electronically storing a set of data entities in a database system, each of the data entities representing an analyzed personal risk tolerance value;
b. electronically storing a set of data entities in a database system, each of the data entities representing an investment security bundle;
c. electronically assigning tags representing relations of the analyzed personal risk tolerance values to a plurality of the investment securities bundles;
d. selecting a plurality of investment securities bundles represented by data entities for inclusion in a plurality of portfolios of investment securities;
e. correlating the selected investment securities bundles corresponding to an analyzed personal risk tolerance values into at least a first high risk diversified group and a second low risk diversified group based on at least one first common high risk attribute and at least one second common low risk attribute accordingly, wherein the analyzed personal risk tolerance values represented by investment securities bundles in the first high risk diversified group share at least one first common high risk attribute, as identified by one or more tags, and the analyzed personal risk tolerance values represented by investment securities bundles in the second low risk diversified group share the second common attribute, as identified by one or more tags;
f. electronically storing the selected investment securities bundles as a database representation of portfolio; and
g. enabling a creating, reading, updating, or deleting operation on the database system representation of the portfolio in the database system.

2. The method of claim 1, further comprising:
a. setting a target analyzed personal risk tolerance value for the investment securities bundles; and
b. periodically rebalancing the investment securities bundles to its target analyzed personal risk tolerance value.

3. The method of claim 1, further comprising transmitting, sending, or relaying information regarding one or more data entities and one or more analyzed personal risk tolerance values to one of more of an exchange, index provider, index calculator, brokerage, asset manager, investment advisor, fund manager, or securities trading platform.

4. The method of claim 3, further comprising using one or more analyzed personal risk tolerance values to buy, sell, short sell, or execute trades in a security, composite, group, or portfolio.

5. The method of claim 1, wherein one or more securities are equities, bonds, derivatives, commodities, funds, or exchange-traded funds.

6. The method of claim 1, further comprising using a financial instrument to achieve a performance characteristic.

7. The method of claim 6, wherein the financial instrument is selected from among equities, bonds, derivatives, commodities, funds, or exchange traded funds.

8. The method of claim 1, wherein the analyzed personal risk tolerance values represented by investment securities by electronically calculating the personal financial risk tolerance (PFRT) of a user by operating a computer implemented survey of financial risk tolerance (SOFRT) calculator for calculating said PFRT of said user.

9. The method of claim 1, further comprising:
a. receiving, as an input, a target performance metric from a user;
b. receiving, as an input, an analyzed personal risk tolerance value of said user;
c. evaluating a portfolio to determine whether it meets, or is projected to meet, the performance metric; or
d. constructing a portfolio, group, or subgroup so as to achieve the performance metric.

10. The method of claim 9, wherein the performance metric is an expected quantified return corresponding on the measure of personal tolerance risk.

11. The method of claim 9, wherein the target performance metric is factor-based, performance-based, or capital markets-based.

12. A system for executing a command in a computing environment to construct a representation of diversified investment securities correlating to user risk tolerance value in a database, the system comprising:
a. a computerized processor configured for:
(i) electronically assigning tags representing attributes of the analyzed personal risk tolerance values to a plurality of the investment securities bundles;
(ii) selecting a plurality of investment securities bundles represented by data entities for inclusion in a plurality of portfolios of investment securities;
(iii) correlating the selected investment securities bundles corresponding to an analyzed personal risk tolerance values into at least a first high risk diversified group and a second low risk diversified group based on at least one first common high risk attribute and at least one second common low risk attribute accordingly, wherein the analyzed personal risk tolerance values represented by investment securities bundles in the first high risk diversified group share at least one first common high risk attribute, as identified by one or more tags, and the analyzed personal risk tolerance values represented by investment securities bundles in the second low risk diversified group share the second common attribute, as identified by one or more tags;
(iv) enabling a creating, reading, updating, or deleting operation on the database system representation of the portfolio in the database system.
b. an electronic data store configured for:
(i) electronically storing a set of data entities in a database system, each of the data entities representing an analyzed personal risk tolerance value;
(ii) electronically storing a set of data entities in a database system, each of the data entities representing an investment security bundle; and
(iii) electronically storing the selected investment securities bundles as a database representation of portfolio.

13. The system of claim 12, wherein the computerized processor is further configured for:
a. setting a target analyzed personal risk tolerance value for the investment securities bundles; and
b. periodically rebalancing the investment securities bundles to its target analyzed personal risk tolerance value.

14. The system of claim 12, wherein the computerized processor is further configured for transmitting, sending, or relaying information regarding one or more data entities and one or more analyzed personal risk tolerance values to one of more of an exchange, index provider, index calculator, brokerage, asset manager, investment advisor, fund manager, or securities trading platform.

15. The system of claim 14, wherein the computerized processor is further configured for using one or more analyzed personal risk tolerance values to buy, sell, short sell, or execute trades in a security, composite, group, or portfolio.

16. The system of claim 12, wherein one or more securities are equities, bonds, derivatives, commodities, funds, or exchange-traded funds.

17. The system of claim 12, wherein the computerized processor is further configured for using a financial instrument to achieve a performance characteristic.

18. The system of claim 17, wherein the financial instrument is selected from among equities, bonds, derivatives, commodities, funds, or exchange traded funds.

19. The system of claim 12, wherein the computerized processor is further configured for representing the analyzed personal risk tolerance values of the investment securities by electronically calculating the personal financial risk tolerance (PFRT) of a user by operating a computer implemented survey of financial risk tolerance (SOFRT) calculator for calculating said PFRT of said user.

20. The system of claim 12, wherein the computerized processor is further configured for:
a. receiving, as an input, a target performance metric from a user;
b. receiving, as an input, an analyzed personal risk tolerance value of said user;
c. evaluating a portfolio to determine whether it meets, or is projected to meet, the performance metric; or
d. constructing a portfolio, group, or subgroup so as to achieve the performance metric.

21. The system of claim 20, wherein the performance metric is an expected quantified return corresponding on the measure of personal tolerance risk.

22. The system of claim 20, wherein the target performance metric is factor-based, performance-based, or capital markets-based.
